(19) United States
(12) Patent Application Publication
(10) Pub. No.: US 2020/0276999 A1
(43) Pub. Date: Sep. 3, 2020

(54) ROTATIONAL HANDLE ASSEMBLY FOR STROLLERS

(71) Applicant: Jay M. Fanelli, Lafayette, CA (US)

(72) Inventor: Jay M. Fanelli, Lafayette, CA (US)

(21) Appl. No.: 16/289,348

(22) Filed: Feb. 28, 2019

(51) Int. Cl. B62B 9/20

(52) U.S. Cl. CPC B62B 9/206; B62B 7/044

(57) ABSTRACT

A rotational handle assembly for strollers. The rotational handle assembly includes a pair of handle members. The handle members have a mount end, a body section, and a grip end. The mount end pivotally mounts to a stroller handle bar. The horizontal handle bar extends along a horizontal plane. The grip end of the handle members is used to control forward, rearward, side to side motion of the stroller; and pivotal manipulations of the handle members. A pair of clamps rotatably fasten the handle members to the horizontal handle bar of stroller.

### BACKGROUND

The present disclosure relates generally to rotational handle assemblies and more specifically to rotational handle assembly for strollers or the like.

Strollers or baby carriages are hand-pushed vehicles used for transporting babies and smaller children. Many variations of such strollers exist. An example is a jogging stroller that allows the user to jog while pushing the stroller. The multiple wheels at the base of the jogging stroller carriage allows for mobility of the user during jogging.

Generally, jogging strollers (and other stroller types) have fixed horizontal handles that provide a gripping surface for the user to hold onto while manipulating the stroller. In many instances, operation of the stroller can be cumbersome since the user's arm must typically remain immobile in a substantially horizontal position to manipulate the stroller, resulting in stress on the arms and wrists of the user.

It is within the aforementioned context that a need for the present disclosure has arisen, and the present disclosure meets this need.

### BRIEF SUMMARY

Various aspects of a rotational handle assembly for strollers can be found in examples of the present disclosure.

In one aspect, the rotational handle assembly is pivotally attached to the stroller handle bar to facilitate pushing, pulling, steering, and general manipulation of the stroller. In one example, the rotational assembly includes a pair of handles that pivotally attach to the horizontal handle bar of the stroller. This pivotal articulation relative promotes natural swaying of the arms thus reducing stress on the wrists and arms of the user while operating the stroller.

In another aspect, the rotational handle assembly may axially rotate forwardly and rearwardly relative to a vertical plane of the horizontal handle bar of the stroller. Further, such axial rotation in the forward direction may continue until a first stop position is reached; after which the rotation is in a reverse direction until a second stop position is reached. The user or stroller operator may control the direction and extent of the rotation, through movement of the wrists and arms.

In one example, the pair of handles include a mount end, a body section, and a grip end. In some examples, the grip end has a C-shaped configuration that provides a natural fit for the hand. The mount end of the handles is configured for pivotally mounting onto the stroller handle bar. In some examples, the mount end is pivotally clamped to the horizontal handle bar.

The assembly is also unique in that each one of the pair of handles may partially rotate in two directions about the horizontal handle bar of the stroller. However, in alternative examples, the pair of handles is restricted to partially rotate in two directions about the horizontal handle bar, while below the horizontal plane. This provides a lower grip angle for user, if desired.

In addition, the pair of handles partially rotate in an upward and downward direction about the horizontal plane of the horizontal handle bar. In yet another example, the pair of handles partially rotate about the horizontal handle bar in a forward and backward direction relative to a vertically disposed plane of the horizontal handle bar.

In some examples, the body section of each of the pair of handles may have one of the following shapes: a linear shape, a bowed shape, a tortuous shape, and a U-shape. In addition, the mount end of the handle members is perpendicular to the body section of the handle members.

A further understanding of the nature and advantages of the present disclosure herein may be realized by reference to the remaining portions of the specification and the attached drawings. Further features and advantages of the present disclosure, as well as the structure and operation of various examples of the present disclosure, are described in detail below with respect to the accompanying drawings. In the drawings, the same reference numbers indicate identical or functionally similar elements.

### BRIEF DESCRIPTION OF THE DRAWINGS

FIG. 1 illustrates a rotational handle assembly attached to a stroller handle bar according to an example of the present disclosure.

FIG. 2 illustrates the rotational handle assembly shown in FIG. 1 according to an example of the present disclosure.

FIG. 3 illustrates a rear view of the rotational handle assembly of the present disclosure.

FIG. 4A shows an example U-shaped handle member.

FIG. 4B shows an example tortuous-shaped handle member.

FIG. 4C shows an example U-shaped handle member.

FIG. 5 illustrates an alternative rotational handle assembly according to an example of the present disclosure.

FIG. 6 illustrates another example of the rotational handle assembly shown of FIG. 1.

### DETAILED DESCRIPTION

Reference will now be made in detail to the examples of the disclosure, examples of which are illustrated in the accompanying drawings. While the disclosure will be described in conjunction with the preferred examples, it will be understood that they are not intended to limit the disclosure to these examples. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth to provide a thorough understanding of the present disclosure. However, it will be obvious to one of ordinary skill in the art that the present disclosure may be practiced without these specific details. In other instances, well-known methods, procedures, components, and circuits have not been described in detail as to not unnecessarily obscure aspects of the present disclosure.

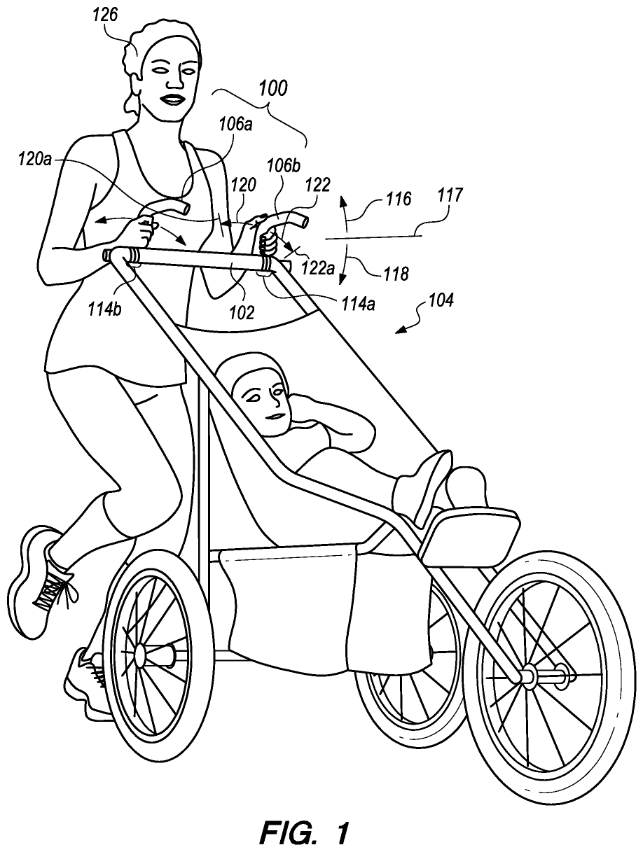

FIG. 1 illustrates a rotational assembly 100 for strollers.

In FIG. 1, rotational assembly 100 pivotally attaches to a stroller handle bar 102 of a stroller 104. Rotational assembly 100 can then be gripped by user 126 while pushing, pulling, steering, and general manipulation of stroller 104. Here, although stroller 104 of FIG. 1 has been depicted as a jogging stroller, the present disclosure is applicable to other types of strollers and mobile carriages.

[24] Rotational assembly 100 includes a pair of connecting handles 106a, 106b. User 126 can hold connecting handles 106a, 106b while pushing, pulling, and steering stroller 104. The pivotal articulation of rotational assembly 100 relative to the horizontal stroller handle bar 102 works to reduce stress on the wrists and arms of user 126 while operating stroller 104.

For example, assume that user 126, a typical jogger, is jogging without a stroller. Naturally, user 126's arms would sway in a forward and backward direction. Rotational assembly 100 of the present disclosure promotes this natural forward and backward sway of the arms. As shown in FIG. 1, user 126 is pushing stroller 104 during a jogging activity. User 126's arm is gripping connecting handle 106b. As jogging proceeds, connecting handle 106 is configured to rotate axially in a forward direction 122 away from the user and in a backward direction 120 proximal to user 126.

In this manner, unlike conventional systems where the user's arm must remain fixed and stationary on a stroller handle bar, the present disclosure uses the articulating and rotational assembly 100 to replicate the user's natural motion when a stroller is pushed. The present disclosure significantly reduces and/or prevents the stress and fatigue experienced by users' arms and wrist with conventional stroller activities.

This rotatable adjustability is possible because rotational assembly 100 can axially rotate forwardly and rearwardly relative to stroller handle bar 102. In one non-limiting example, this axial rotation can be up to 45° in both directions. In other examples, greater or less degrees of freedom for connecting handles 106a, 106b may be possible.

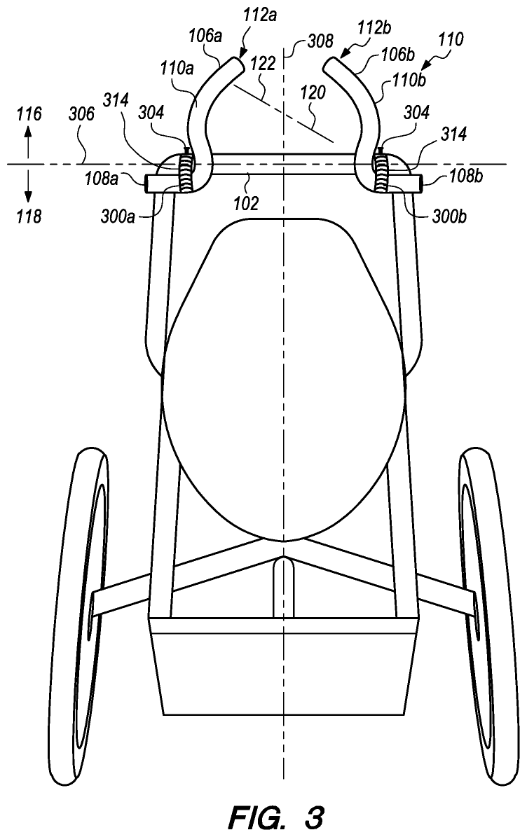

Further, rotational assembly 100 axially rotates in such forward direction 122 until a first stop position 122A is reached; and then rotates in a backward direction 120 until a second stop position 120A is reached. First stop position 122A may be positioned at a 45 degree angle relative to vertical plane 308 (FIG. 3), while second stop position is similarly positioned at a 45 degree angle relative to vertical plane 308. However, those of ordinary skill in the art will realize that the stop positions may be varied as desired by a user. The stop positions provide a stable point for holding connecting handles 106a, 106b. User 126 controls the direction and extent of the rotation of connecting handles 106a, 106b, through manipulation of the wrists and arms against stroller handle bar 102.

In another example, in addition to or in lieu of axial rotation in forward direction 122 and backward direction 120, axial rotation may be in an upward direction 116 and downward direction 118. Where movement is in upward direction 116 and downward direction 118, such movement is with respect to the horizontal plane 117 (or horizontal plane 306 of FIG. 3) along which the stroller handle bar 102 extends.

In FIG. 1, in one implementation, stroller handle bar 102 may be part of a stroller handle subassembly that is integral with stroller 104. Such a stroller handle subassembly might include the connecting handles 106a, 106b both integrated with stroller handle bar 102 during manufacture of the stroller. The stroller handle subassembly may include C-shaped or U-shaped handles.

Referring now to connecting handles 106a, 106b, the axial rotation in upward and downward directions 116, 118 about horizontal plane 306 (FIG. 3) may be a partial rotation. Upward direction 116 is oriented away from the ground surface, and downward direction 118 is oriented toward the ground surface. Connecting handles 106a, 106b may also partially rotate in forward and backward direction 122, 120 relative to vertical plane 308 (FIG. 3). Forward direction 122 is oriented in the forward movement followed by stroller 104. Backward direction 120 is oriented toward user 126 behind stroller 104.

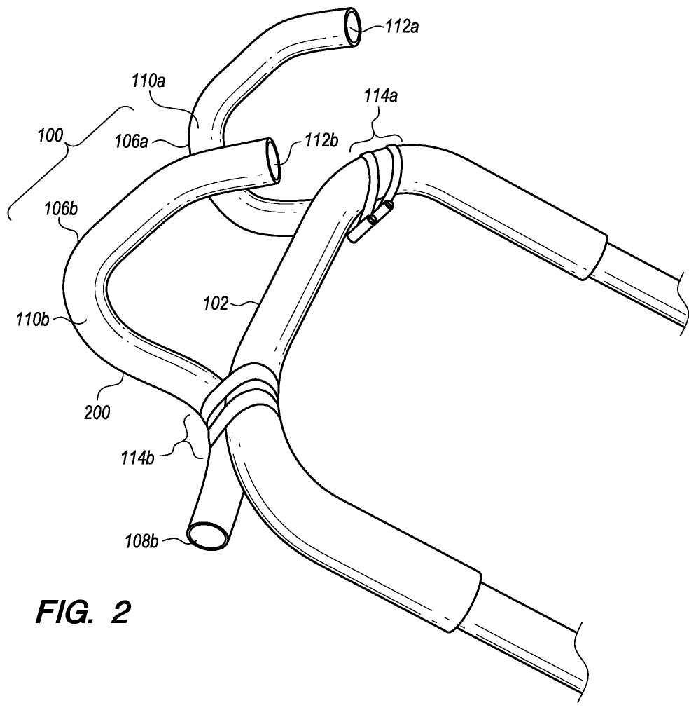

As FIG. 2 illustrates, rotational assembly 100 disposes the pair of connecting handles 106a, 106b in a spaced-apart relationship across stroller handle bar 102. Connecting handles 106a, 106b are detachably attached to stroller handle bar 102, so that the distance between the handle members can be adjusted by user 126. In this manner, connecting handles 106a, 106b may be spaced at a natural shoulder width distance, so as to provide a natural gripping alignment for user 126.

Turning now to FIG. 3, stroller handle bar 102 extends along a horizontal plane 306. Horizontal plane 306 provides a reference point for rotation of connecting handles 106a, 106b in the upward and downward directions 116, 118. A vertical plane 308 also provides a point of reference for rotation of connecting handles 106a, 106b in the forward and backward directions 122, 120.

Connecting handles 106a, 106b are defined by a mount end 108a, 108b, a C-shaped body section 110a, 110b, and a grip end 112a, 112b, respectively. Grip end 112a provides a surface for gripping connecting handle 106a. In some examples, the C-shaped configuration of grip end 112a can provide a natural fit for the hand of user 126. Grip end 112a may have a foam sleeve for additional grip comfort when the stroller is operated.

Body section 110a is a rigid, C-shaped configuration (in one implementation) that extends between the grip end 112a and mount end 108 of connecting handle 106a. In the C-shaped configuration, body section 110a forms a convex shape that protrudes toward user 126 for proximity to the hands of user 126.

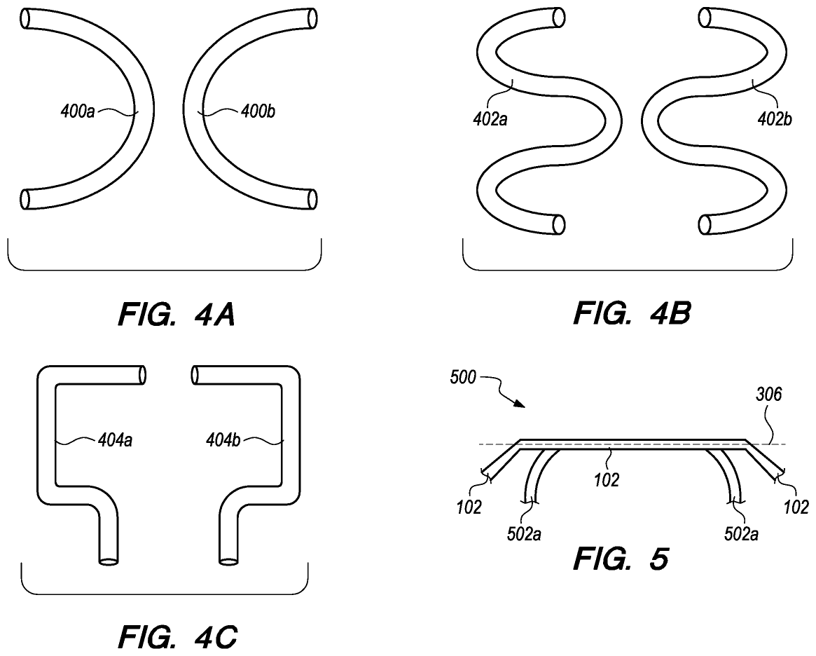

However, as shown in FIGS. 4A through 4C, body section 110a may have other shapes, including, without limitation, a bowed shape 400a, 400b, a tortuous shape 402a, 402b, and a U-shape 404a, 404b. The various shapes are configured for efficient rotation and operator comfort. Body section 110a may be fabricated from a rigid material that does not rust, including, without limitation, a rigid polymer, a metal alloy, aluminum, rubber, and wood.

Mount end 108a of connecting handle 106a is configured for pivotally mounting to stroller handle bar 102 of stroller 104. In one non-limiting example, mount end 108a is oriented substantially perpendicularly to its adjoining body section 110a. This perpendicular orientation provides a parallel mounting position with stroller handle bar 102.

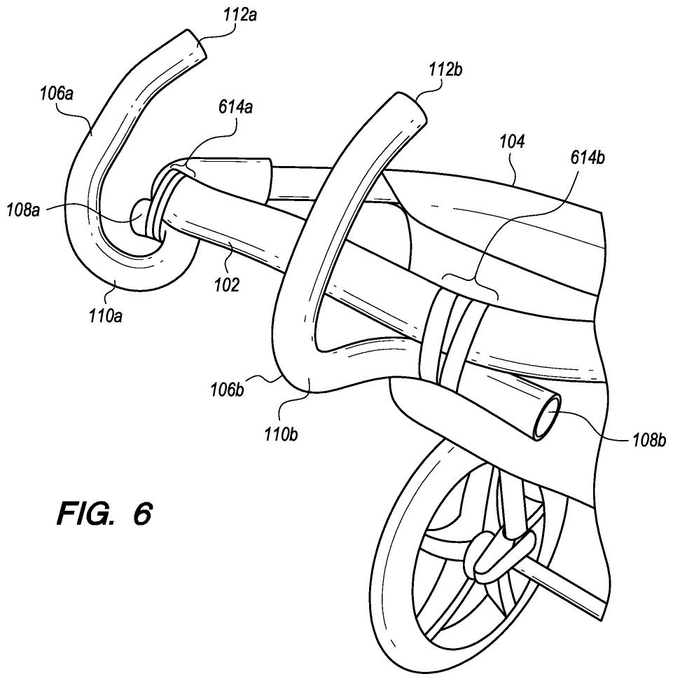

In FIG. 3, as noted, mount end 108a is pivotally mounted to stroller handle bar 102. In this example, pivot mounting is via a pair of clamps 614a, 614b, ADD TO FIGURE, as discussed with reference to FIG. 6. In this manner, connecting handles 106a, 106b at least partially rotate about stroller handle bar 102 of the stroller. Thus, the pivotal attachment of the mount end 108a, 108b allows connecting handles 106a, 106b to at least partially rotate in two directions about stroller handle bar 203.

FIG. 5 illustrates rotational assembly 500, which is another example of rotational assembly 100 of FIG. 1. Here, rotational assembly 500 includes a pair of connecting handles 502a, 502b that rotate below horizontal plane 306 of stroller handle bar 102. As discussed below, although not required, one or more springs 300a, 300b may restrict connecting handles 502a, 502b below the horizontal plane 306. Notwithstanding said springs, this lower positioning connecting handles 502a, 502b provides user 126 with a lower arm swaying as the user pushes the stroller.

FIG. 6 illustrates rotational assembly 100 including a pair of fasteners such as clamps 614a, 614b [CHANGE 114B IN FIG. 6. Here, clamps 614a, 614b detachably fasten mount end 108a, 108b to stroller handle bar 102. Clamps 614a, 614b are detachable such that connecting handles 106a, 106b can be removed, adjusted, and manipulated directly from stroller handle bar 102.

Further, clamps 614a, 614b are rotatable about stroller handle bar 102, such that connecting handles 106a, 106b at least partially rotate in two directions about stroller handle bar 102. A fastener 304 may secure clamp 614a, 614b to stroller handle bar 102, or to connecting handles 106a, 106b, or both. The fastener 304 may include, without limitation, a screw, a bolt, a lock, a pin, a magnet, and a tether.

Clamps 614a, 614b may include a resilient metal strap that wraps around mount end 108a, 108b of connecting handles 106a, 106b and stroller handle bar 102. In yet other examples, clamps 614a, 614b may include a rotational gear mechanism that fixedly attaches to stroller handle bar 102. One skilled in the art will realize that any comparable fastener or clamping mechanisms may be utilized.

Referring now to FIG. 3, clamps 614a, 614b comprise a locking mechanism 302 to help regulate the axial rotation and extent of the rotation. The Locking mechanism 302 fixedly fastens connecting handles 106a, 106b in angular positions relative to stroller handle bar 102.

In one non-limiting example, locking mechanism 302 may include an incremental mechanical device that allows connecting handles 106a, 106b to axially rotate in a controlled, incremental motion about stroller handle bar 102. Locking mechanism 302 can also be configured to enable connecting handles 106a, 106b to rotate freely in two directions about stroller handle bar 102.

Referring to FIG. 3, clamps 614a, 614b include one or more springs 300a, 300b. The springs position across clamps 614a, 614b, or locking mechanism 302, so as to generate tension when connecting handles 106a, 106b are rotated beyond a tension point, such as below the horizontal plane 306. In this manner, connecting handles 106a, 106b axially rotate, and maintain a position above the horizontal plane 306 of stroller handle bar 102.

For example, as user 126 pulls connecting handles 106a, 106b in downward direction 118, and toward horizontal plane 306, springs 300a, 300b are extended and the tension load is increased until connecting handles 106a, 106b are pulled back above the horizontal plane 306. However, as discussed above, and as shown in FIG. 5, connecting handles 106a, 106b may also be positioned below horizontal plane 306. In this alternative configuration, springs 300a, 300b may be removed, or their orientation spring reversed.

While the above is a complete description of exemplary specific examples of the disclosure, additional examples are also possible. Thus, the above description should not be taken as limiting the scope of the disclosure, which is defined by the appended claims along with their full scope of equivalents.

1. A rotational handle assembly for strollers comprising:
a pair of handle members defined by a mount end, a body section, and a grip end, the mount end of the handle members configured for pivotally mounting to a horizontal handle bar, the horizontal handle bar extending along a horizontal plane, wherein the handle members partially rotate axially about the horizontal handle bar.

2. The assembly of claim 1, wherein the handle members partially rotate in two directions about the horizontal handle bar.

3. The assembly of claim 1, wherein the handle members are restricted to partially rotate in two directions about the horizontal handle bar, below the horizontal plane.

4. The assembly of claim 1, wherein the handle members partially rotate in an upward and downward direction about the horizontal plane of the horizontal handle bar.

5. The assembly of claim 1, wherein the handle members partially rotate about the horizontal handle bar in a forward and backward direction relative to a vertically disposed plane of the horizontal handle bar.

6. The assembly of claim 1, wherein the handle members rotate between a first stop position and a second stop position.

7. The assembly of claim 6, wherein the handle members rotate axially in a forward direction until a first stop position is reached; and rotate in a reverse direction until a second stop position is reached.

8. The assembly of claim 1, wherein the horizontal handle bar comprises a stroller handle subassembly integral with the stroller.

9. The assembly of claim 1, wherein the mount end of the handle members are oriented perpendicularly to the body section of the handle members.

10. The assembly of claim 1, wherein the body section of the handle members are defined by a C-shape.

11. The assembly of claim 1, wherein the body section of the handle members include at least one of the following shapes: a linear shape, a bowed shape, a tortuous shape, and a U-shape.

12. The assembly of claim 1, wherein the mount end of the handle members is perpendicular to the body section of the handle members.

13. The assembly of claim 1, wherein the handle members are disposed in a spaced-apart relationship along the horizontal handle bar.

14. The assembly of claim 1, further comprising a pair of clamps detachably fastening the mount end of the handle members to the horizontal handle bar, the clamps being rotatable about the horizontal handle bar.

15. The assembly of claim 14, wherein the clamps comprise a locking mechanism and a fastener.

16. The assembly of claim 15, wherein the locking mechanism fixedly fastens the handle members in at least two angular positions relative to the horizontal handle bar.

17. The assembly of claim 16, wherein the clamps comprise at least one spring.

18. The assembly of claim 17, wherein the at least one spring operationally attaches to the locking mechanism, the spring generating tension when the handle members are rotated below the horizontal plane, such that the handle members are urged to axially rotate above the horizontal plane.

19. A rotational handle assembly for strollers comprising:
a pair of handle members defined by a mount end, a body section, and a grip end, the mount end configured for pivotally mounting to a stroller handle bar, the horizontal handle bar extending along a horizontal plane, wherein the handle members partially rotate about the horizontal handle bar in a forward and backward direction relative to a vertically disposed plane of the horizontal handle bar, wherein the handle members rotate axially in a forward direction until a first stop position is reached, and rotate in a reverse direction until a second stop position is reached;
a pair of clamps detachably fastening the mount end of the handle members to the horizontal handle bar; and
a locking mechanism fixedly fastening the handle members in at least two angular positions relative to the horizontal handle bar.

20. A rotational handle assembly for strollers consisting of:
a pair of handle members defined by a mount end, a C-shaped body section, and a grip end, the mount end of the handle members configured for pivotally mounting to a stroller handle bar, the mount end of the handle members disposed perpendicular to the body section, the grip end of the handle members configured for enabling gripping of the assembly by a stroller operator, the horizontal handle bar extending along a horizontal plane, wherein the handle members partially rotate about the horizontal handle bar in a forward and backward direction relative to a vertically disposed plane of the horizontal handle bar, wherein the handle members rotate axially in a forward direction until a first stop position is reached; and rotates in a reverse direction until a second stop position is reached;
a pair of fasteners that attach the mount end of the handle members to the horizontal handle bar;
a locking mechanism fixedly fastening the handle members in at least two angular positions relative to the horizontal handle bar; and
at least one spring operationally attached to the locking mechanism, the spring generating tension when the handle members are rotated below the horizontal plane, such that the handle members are urged to axially rotate above the horizontal plane.
